(19) United States
(12) Patent Application Publication
(10) Pub. No.: US 2023/0254033 A1
(43) Pub. Date: Aug. 10, 2023

(54) INTERFERENCE MONITORING AND ANALYSIS PLATFORM AND METHODS FOR USE THEREWITH

(71) Applicant: Magnestar Inc., Toronto (CA)

(72) Inventors: Jacqueline Good, Toronto (CA); Michael O'Meara, Verdun (CA); Paul Laforge, Regina (CA); John Russell, Guelph (CA)

(73) Assignee: Magnestar Inc., Toronto (CA)

(21) Appl. No.: 18/163,701

(22) Filed: Feb. 2, 2023

Related U.S. Application Data
(60) Provisional application No. 63/306,875, filed on Feb. 4, 2022.

(51) Int. Cl. H04B 7/185; G08B 21/18

(52) U.S. Cl. CPC H04B 7/18519; G08B 21/18; H04B 7/18567; H04B 7/18513

(57) ABSTRACT

A space system operates to: receive, via a network interface, communication conditions data and space system data, wherein the space system data includes space object data corresponding to a plurality of space objects and a plurality of space clients and wherein the communication conditions data includes weather service data indicating atmospheric conditions adverse to space communications; generate, responsive to the communications condition data and the space systems data, interference prediction data that indicates at least one predicted interference condition corresponding to communications corresponding to at least one of the plurality of space objects; generate, responsive to the interference prediction data, one or more interference alerts indicating the at least one predicted interference condition at the at least one of the plurality of space objects; and send, via the network interface, the one or more interference alerts to one or more of the plurality of space clients.

### CROSS REFERENCE TO RELATED APPLICATIONS

The present U.S. Utility Patent application claims priority pursuant to 35 U.S.C. § 119(e) to U.S. Provisional Application No. 63/306,875, entitled “MAKING SPACE SAFE FOR HUMANS,” filed Feb. 4, 2022, which is hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This disclosure relates generally to satellite systems and more particularly to systems for monitoring and analyzing satellite communications and interference.

### BRIEF DESCRIPTION OF THE SEVERAL VIEWS OF THE DRAWING(S)

FIG. 1 is a schematic block diagram illustrating communication links utilized by example space objects in accordance with various embodiments;

FIG. 2A is a schematic block diagram of an example interference monitoring and analysis platform in accordance with various embodiments;

FIG. 2B is a schematic block diagram of an example satellite system in accordance with various embodiments;

FIG. 3A is a schematic block diagram of a portion of an example interference monitoring and analysis platform in accordance with various embodiments;

FIG. 3B is a schematic block diagram of a portion of an example interference monitoring and analysis platform in accordance with various embodiments;

FIGS. 4A-4D are pictorial diagrams of example screen displays in accordance with various embodiments; and

FIG. 5 is a flowchart diagram illustrating an example of a method in accordance with various embodiments.

### DETAILED DESCRIPTION OF THE INVENTION

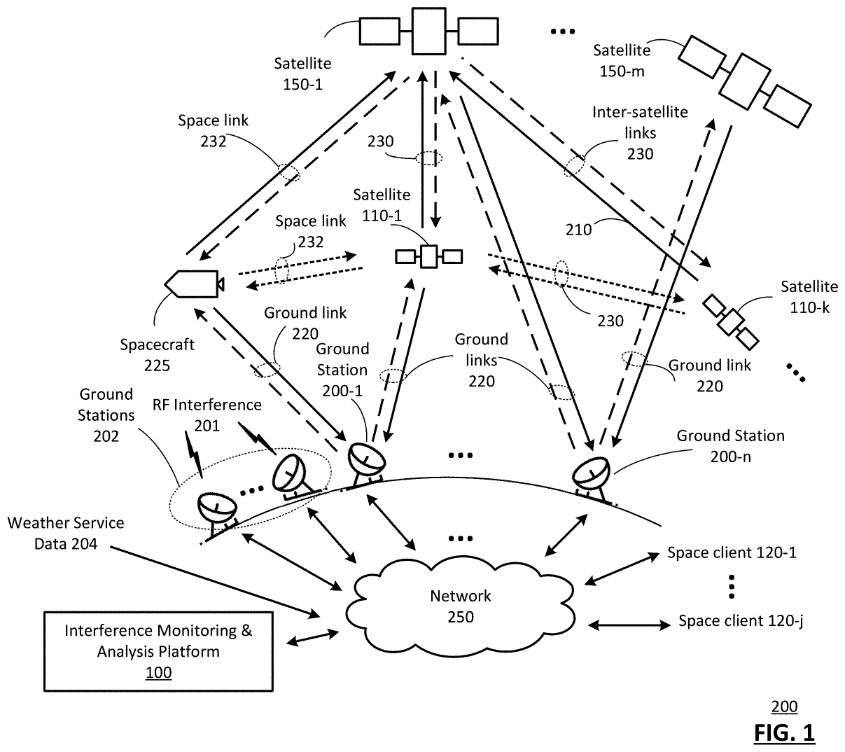

FIG. 1 is a schematic block diagram 200 illustrating communication links utilized by example space objects. The example shown includes a plurality of satellites 110-1 . . . 110-k, which can be implemented via combination of devoted purpose-built satellites, purpose-built payloads on a standard satellite bus, and/or hosted payloads or services part of another satellite network. These satellites can make use of commercial-of-the-shelf (COTS) components and be compatible with CubeSat and other standard bus architectures. In some embodiments, some or all of the plurality of satellites 110 of satellite constellation system orbit in accordance with low earth orbit (LEO) and can be referred to as “LEO satellites”. Additional satellites 150-1 . . . 150-m are shown that orbit in accordance with medium earth orbit (MEO), and/or geostationary orbit (GEO). In addition, a spacecraft 225 is shown in a LEO. In other examples, the spacecraft 225 may be in a MEO or GEO or in other orbital or non-orbital positions. These space objects (e.g., satellites 110 and 150, and spacecraft 225, etc.) communicate with one or more ground-based space clients 120-1 . . . 120-j that include the operators of different satellites and/or satellite constellations and/or government entities that control and/or monitor these space objects via network 250, and also end-users of services enabled by such space objects via, for example, end-user devices that communicate with one or more satellites 110 or 150.

In the example shown, the satellites 110, 150 and/or spacecraft 225 can communicate with one or more ground stations 200-1 . . . 200-n via ground links 220. These ground links 220 include downlink communications sent from satellites 110, 150 and/or spacecraft 225 to one or more ground stations 200, and uplink communications originating from one or more ground stations 200 intended to be received by at least one satellite 110, 150 and/or spacecraft 225.

Some or all of the satellites 110 and/or 150 can receive signals from each other via inter-satellite links 230. Each inter-satellite link 230 corresponds to a link between two or more satellites 110 or 150. These inter-satellite links can be omni-directional links such that the transmission is one-to-many, dedicated links between satellite pairs in different orbital planes, and/or dedicated links between satellite pairs within the same orbital plane. A single satellite 110 can be capable of transmitting and/or receiving from any combination of these types of inter-satellite links. These inter-satellite links can either be dedicated data links or can include data that is modulated onto another signal being broadcast by the satellite. In addition, the spacecraft 225 can communicate via one or more satellites 110 and/or 150 utilizing space links 232. Any signals transmitted and/or received by any of the space objects can travel through a single links (e.g., ground link only) and/or through any combination of links (e.g., a ground link 220, space link 232 and/or one or more inter-satellite links 230).

The ground stations 200 can be configured to communicate via a network 250 utilizing a communication interface. In various examples, a ground station 200 can be a transceiver system of an operator or an end user and may be either stationary or mobile. The network 250 can be implemented utilizing a wired and/or wireless communication network and can include a cellular network, the Internet, and/or one or more local area networks (LAN), private networks and/or wide area networks (WAN).

Consider that new satellites are being launched on a regular basis and the number of space objects is increasing rapidly. Not only is the possibility of interference increasing with the increased number of space-based communication links (e.g., ground links 220, inter-satellite links 230 and space links 232), each of these links are subject to disruptions due to radio frequency (RF) interference (e.g., RFI) caused by solar flares, coronal mass ejections, magnetic storms, cosmic noise. Each of these links are also subject to other space-originating RF interference (e.g., co-linear vector satellite/spacecraft interference events caused by other space objects and/or other types of RF interference) that is adverse to space communications. For example, if Telesat is providing backhaul cell phone reception in a Ka band over a ground station 200 in a given region such as Montreal and Starlink comes about and is downlinking in the same band over the given region, this event of multiple satellites communicating in the same band over the given region is a cause of potential interference. Furthermore, if an earth observation satellite is dynamically downlinking based on where their customer is requesting earth imagery, they would need to know in near real-time whether a given ground station has capacity for downlinking or if they will be interfering with other satellites communicating in the region in a similar band; which would cause interference.% This could also be the same for any kind of spacecraft to satellite, satellite to spacecraft and spacecraft to spacecraft interference. Additionally, each of these links are also subject to disruptions due to interactions with the Earth's atmosphere caused by weather conditions such as clouds, rain, hail, sleet, etc. Any of these disruptions can cause degradations in performance and even outages for operators and users on Earth.

The system shown further includes interference monitoring and analysis platform 100. In various examples, this platform operates to:
receive, via a network interface, communication conditions data and space system data, wherein the space system data includes space object data corresponding to a plurality of space objects and a plurality of space clients and wherein the communication conditions data includes weather service data indicating atmospheric conditions adverse to space communications (received from one or more weather services, for example);
generate, responsive to the communications condition data and the space systems data, interference prediction data that indicates at least one predicted interference condition corresponding to communications associated with at least one of the plurality of space objects;
generate, responsive to the interference prediction data, one or more interference alerts indicating the at least one predicted interference condition associated with the at least one of the plurality of space objects; and
send, via the network interface, the one or more interference alerts to one or more of the plurality of space clients.

In various examples, the space object data includes operator and space systems data such as the names, operators, two-line element sets, special perturbation vectors and/or other orbital state vectors (e.g., position, velocity, orbit, apogee, perigee, pointing data and/or other orientation data and/or data associated with current and/or planned maneuvers), and/or uplink, downlink, intersatellite frequencies and/or other spectral information associated with the plurality of space objects being monitored by the interference monitoring and analysis platform 100, in addition to signal regulations data such as spectral and other communication rules established by the Federal Communication Commission (FCC), the International Telecommunication Union (ITU), and/or other regulatory or standards organizations.

In various examples, the communication conditions data further includes radio frequency (RF) interference data (e.g., RFI data) indicating space-originating RF interference adverse to space communications. At least a portion of the RF interference data can be received from a plurality or ground stations 202 such as radio telescopes or other radio astronomy systems, antenna/receiver systems dedicated to interference monitoring and/or to the interference monitoring and analysis platform 100, antenna/receiver systems of amateur and/or commercial radio operators and/or other stationary and/or mobile systems that receive corresponding RF interference 201. In addition or in the alternative, at least a portion of the RF interference data is generated via a plurality of sensors (such as small component satellite sensor hardware) corresponding to or otherwise incorporated with a subset of the plurality of space objects, wherein each of the plurality of sensors is dedicated to detection of space-originating RF interference adverse to space communications (generated either celestially of via one or more other space objects), and wherein the at least a portion of the RF interference data generated by such sensors is incorporated into downlink communications received from the subset of the plurality of space objects.

In various examples, the one or more interference alerts classify the at least one predicted interference condition as at least one of: inter-satellite communication interference, satellite uplink communication interference, or satellite downlink interference. The at least one predicted interference condition can correspond to a future condition. In addition or in the alternative, the interference monitoring and analysis platform 100 operates to generate, based on the interference alerts and at least a portion of the space system data, prescriptive actions data that indicates prescriptive actions for mitigating the at least one predicted interference condition prior to the future condition. These prescriptive actions can include one or more of:
adjusting a downlink frequency (e.g., channel, band, etc.) of the at least one of the plurality of space objects,
adjusting an uplink frequency (e.g., channel, band, etc.) of the at least one of the plurality of space objects,
adjusting a downlink frequency (e.g., channel, band, etc.) of at least another one of the plurality of space objects,
adjusting an uplink frequency (e.g., channel, band, etc.) of the at least another one of the plurality of space objects,
adjusting a downlink transmission power of the at least one of the plurality of space objects,
adjusting a downlink transmission power of at least another one of the plurality of space objects, adjusting an uplink transmission power of a ground station communicating with the at least one of the plurality of space objects,
adjusting an uplink transmission power of a ground station communicating with the at least another one of the plurality of space objects,
rerouting an uplink transmission to the at least one of the plurality of space objects via uplink transmission to another space object of the plurality of space objects and inter-satellite communications from the another space object of the plurality of space objects to the at least one of the plurality of space objects, and/or
rerouting a downlink transmission from the at least one of the plurality of space objects via intersatellite transmission to another space object of the plurality of space objects and downlink communications from the another space object of the plurality of space objects.

In addition or in the alternative, the interference monitoring and analysis platform 100 operates to generate a graphical user interface for display via a client device of one of the plurality of space clients; and receive, via the graphical user interface, alerts selection data selected by a user of the client device. The one or more interference alerts can be generated further based on the alerts selection data. The alerts selection data can indicate one or more of:
the at least one of the plurality of space objects,
an operator associated with the at least one of the plurality of space objects,
a spectrum associated the at least one of the plurality of space objects,
a future location associated with the at least one of the plurality of space objects,
and/or an orbit type associated with the at least one of the plurality of space objects.

In addition or in the alternative, the interference monitoring and analysis platform 100 provides software as a service, with associated optional small component satellite sensor hardware, to create a centralized clearing house for signal communications between the Earth and space.

In addition or in the alternative, the interference monitoring and analysis platform 100 monitors spectrum usage by receiving RF interference data from multiple sources, assessing these signals and logging this information in a database in order to determine a real-time view of which spectrum is being communicated where, and/or which operator is using which capacity of their allocated spectrum. This allows the interference monitoring and analysis platform 100 to determine which operators are (and/or are not) using the spectrum they have been allocated—providing not only a better prediction of signal interference, but also a more accurate view of allocated and used spectrum that, for example, can be used to facilitate spectral sharing transactions between operators and/or used to identify unallocated spectrum for new operators.

In addition or in the alternative, the interference monitoring and analysis platform 100 operates by mapping and monitoring communication pathways. If a pathway is expected to experience interference, the interference monitoring and analysis platform 100 can operate to suggest alternative bands to communicate in. In particular, the monitoring and analysis platform 100 can include a database that indicates, for each satellite or other space object and based on its specifications, which bands the space object can could potentially communicate in. In this fashion, the interference monitoring and analysis platform 100 can act as a double-sided marketplace to facilitate spectral sharing where interference is identified, available alternative spectrum/channels/bands are identified as well as potential spectral lessees. The interference monitoring and analysis platform 100 can, in various examples, facilitate spectrum sharing and shifting of communications to other bands based on availability and the real-time electromagnetic environment and/or other communication conditions.

In addition or in the alternative, the interference monitoring and analysis platform 100 provides 24/7 communication signal monitoring to alert satellite operators of significant degraded service ahead of time.

In addition or in the alternative, the interference monitoring and analysis platform 100 provides 24/7 signal monitoring to predict when signal interference will occur for operators, military and regulators, with small component hardware to detect signal attribution.

In addition or in the alternative, the interference monitoring and analysis platform 100 provides an event based electronic exchange where signal communications information is gathered, analyzed, and distributed between companies appropriately. Users/operators can receive access to data and the exchange ecosystem for interference analysis, interference alerting services, new spectrum simulations and spectrum sharing.

In addition or in the alternative, the interference monitoring and analysis platform 100 provides an event-based processing engine to predict for space operators (proactively or on demand) when and where current or future signal interference will occur.

In addition or in the alternative, the interference monitoring and analysis platform 100 provides simulation of new operator constellations to test for interference. In various examples, the interference monitoring and analysis platform 100 operates to receive proposed constellation data corresponding to a proposed constellation of space objects; and generate simulation results, based on the proposed constellation data and the space system data, wherein the simulation results indicate resulting interference conditions associated with the proposed constellation of space objects and indicate prescriptive actions for mitigating the resulting interference conditions.

In addition or in the alternative, the interference monitoring and analysis platform 100 provides a clearing house which sources available spectra for new satellites/constellations to operate and assists new operators in getting faster access to spectrum through demonstrating minimal interference with existing space communications.

In addition or in the alternative, the interference monitoring and analysis platform 100 provides fidelity models to multiple operators as a software service to help operators protect their allocated spectrum.

Further details regarding the operation of the interference monitoring and analysis platform 100 including many additional and alternative features are described in conjunction with the examples presented in the Figures that follow.

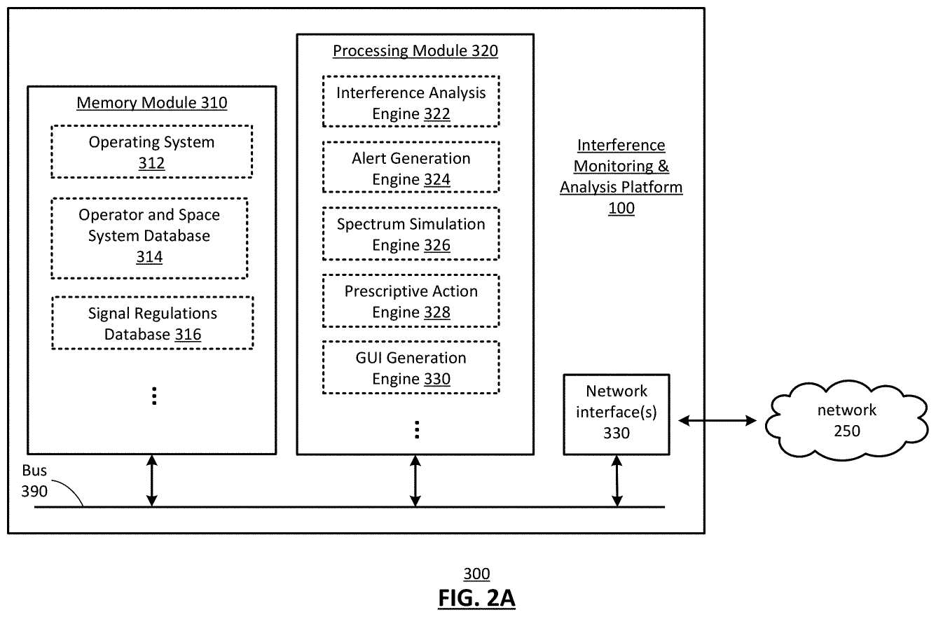

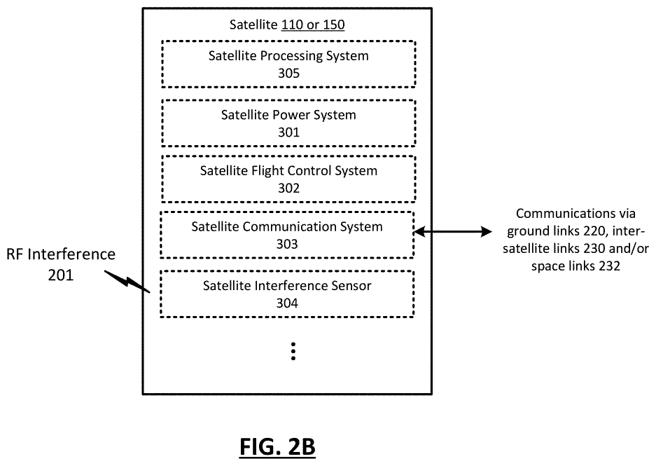

FIG. 2A is a schematic block diagram of an example interference monitoring and analysis platform 100 in accordance with various embodiments. A bus 390 can operably couple and/or facilitate communication between the various components of the interference monitoring and analysis platform 100. While a particular bus configuration is shown, other bus configurations can likewise be employed.

The interference monitoring and analysis platform 100 can include at least one memory module 310 which can be implemented by utilizing at least one memory. Interference monitoring and analysis platform 100 can include at least one processing module 320 which can be implemented utilizing one or more processors. The memory module 310 can store operational instructions that, when executed by the processing module 320, configure the interference monitoring and analysis platform 100 to execute some or all of the functionality of interference monitoring and analysis platform 100 discussed herein.

In some embodiments, the processing module 320 is utilized to implement an interference analysis engine 322 operable to perform some or all of the interference analysis functionality of interference monitoring and analysis platform 100 discussed herein. Alternatively or in addition, the processing module 320 is utilized to implement an alert generation engine 324 operable to perform some or all of the alert generation functionality of interference monitoring and analysis platform 100 as discussed herein. Alternatively or in addition, the processing module 320 is utilized to implement a spectrum simulation engine 326 operable to perform some or all of the spectrum simulation functionality of interference monitoring and analysis platform 100 as discussed herein. Alternatively or in addition, the processing module 320 is utilized to implement a prescriptive action engine 328 operable to perform some or all of the prescriptive action functionality of interference monitoring and analysis platform 100 as discussed herein. Alternatively or in addition, the processing module 320 is utilized to implement a graphical user interface (GUI) generation engine 330 operable to perform some or all of the GUI generation functionality of interference monitoring and analysis platform 100 as discussed herein. The processing module 320 can implement additional engines or other modules not specifically shown.

The memory module 310 can store operational instructions corresponding to the interference analysis engine 322, alert generation engine 324, spectrum simulation engine 326, prescriptive action engine 328, and/or GUI generation engine 330, and when these operational instructions are executed by the processing module 320, the interference monitoring and analysis platform 100 can perform, utilizing the processing module 320, the functionality of the interference analysis engine 322, alert generation engine 324, spectrum simulation engine 326, prescriptive action engine 328, and/or GUI generation engine 330 respectively.

The memory module 310 can also store operational instructions corresponding to an operating system 312 in addition to space system data in the form of operator and space system database 314 that stores operator and space system data, signal regulations database 316 that stores signal regulations data and/or other data as may be desirable to implement the various functionality of interference monitoring and analysis platform 100 as discussed herein.

Interference monitoring and analysis platform 100 can include one or more network interface(s) 330 for communicating with network 250. In operation, the network interface(s) 330 are operable to receive weather service data 204 to communicate with ground stations 200 and/or 202; and/or to communicate with one or more client devices associated with space clients 120 which can include, for example, one or more tablets, smartphones, smartwatches, laptop computers, desktop computers, other computers and computer systems, navigation devices, device location systems, weather systems, marine navigation systems, rail navigation systems, ground vehicles, aircraft, agricultural vehicles, surveying systems, autonomous or highly automated vehicles, UAVs, and/or other client devices associated with space clients 120.

The operations of the interference monitoring and analysis platform 100 can be described further in conjunction with the example that follows. The network interface(s) is/are configured to communicate via the network 250. The memory module 310 includes at least one memory configured to store operational instructions. The processing module includes at least one processor configured to execute the operational instructions, wherein the operational instructions, when executed, cause the processor to perform operations that include:
receiving, via the network interface(s) 330, communication conditions data and space system data, wherein the space system data includes space object data corresponding to a plurality of space objects and a plurality of space clients;
generating, via the interference analysis engine 322 and responsive to the communications condition data and the space systems data, interference prediction data that indicates at least one predicted interference condition corresponding to communications corresponding to at least one of the plurality of space objects;
generating, via an alerts generation engine 324 and responsive to the interference prediction data, one or more interference alerts indicating the at least one predicted interference condition at the at least one of the plurality of space objects; and
sending, via the network interface(s) 330, the one or more interference alerts to one or more of the plurality of space clients 120.

In addition or in alternative to any of the foregoing, the operations further include generating, via the prescriptive action engine 328 and based on the interference alerts and at least a portion of the space system data, prescriptive actions data that indicates prescriptive actions for mitigating the at least one predicted interference condition prior to the future condition.

In addition or in alternative to any of the foregoing, the operations further include generating, via a graphical user interface (GUI) engine 330, a graphical user interface for display via a client device of one of the plurality of space clients; and receiving, via the graphical user interface, alerts selection data selected by a user of the client device; wherein the one or more interference alerts are generated further based on the alerts selection data; and wherein the alerts selection data indicates at least one of: the at least one of the plurality of space objects, an operator associated with the at least one of the plurality of space objects, a spectrum associated the at least one of the plurality of space objects, a future location associated with the at least one of the plurality of space objects, or an orbit type associated with the at least one of the plurality of space objects.

In addition or in alternative to any of the foregoing, the operations further include receiving proposed constellation data corresponding to a proposed constellation of space objects; and generating simulation results, via the spectrum simulation engine 326 and based on the proposed constellation data and the space system data, wherein the simulation results indicate resulting interference conditions associated with the proposed constellation of space objects and indicate prescriptive actions for mitigating the resulting interference conditions.

These functions and features can be used in conjunction with any of the functions and features described further in conjunction with FIG. 1.

FIG. 2B is a schematic block diagram of an example satellite system in accordance with various embodiments. In particular, an example of a satellite 110 or 150 is presented that includes a satellite processing system 305, a satellite power system 301, a satellite flight control system 302, a satellite communication system 303 and a satellite interference sensor 304.

In various examples, the satellite power system 301 includes an array of solar cells, a battery, a fuel cell or other chemical or nuclear power generation system and/or a power management system that operates, for example, under control of the satellite processing system 305 to manage the production, storage and use of electrical power in conjunction with the operation of satellite 110 or 150. The satellite flight control system includes 302 includes one or more propulsion systems, an attitude controller, an inertial stabilizer and/or one or more other devices that operate under of the satellite processing system 305 to maintain, manage and otherwise adjust the orbital position, orientation and/or maneuvering of the satellite 110 or 150.

In various examples, the satellite processing system 305 includes memory that stores data, an operating system including several system utilities, and applications and/or other routines that include operational instructions. The satellite processing system 305 further includes one or more processors that are configured to execute the operational instructions to perform various the functions, features and other operations of the satellite 110 or 150 in conjunction with the satellite power system 301, the satellite flight control system 302, the satellite communication system 303, the satellite interference sensor 304, and/or one or more other onboard devices not expressly shown.

In various examples, the satellite communication system 303 includes one or more receivers, transmitters and/or transceivers configured to engage in communications via ground links 220, inter-satellite links 230 and/or space links 232.

In various examples, the satellite interference sensor 304 includes one or more sensors (such as small component satellite sensor hardware) dedicated to the detection of space-originating RF interference 201 adverse to space communications (generated either celestially or via one or more other space objects) and, for example, an attribution associated with the space-originating RF interference 201 such as being either of celestial origin or originating at an identified space object. In an example of operation, the satellite interference sensor 304 generates RF interference data indicating the space-originating RF interference 201 and/or its attribution. This RF interference data is incorporated, via the satellite processing system 305, into downlink communications that are transmitted by the satellite communication system 303 via ground links 220, inter-satellite links 230 and/or space links 232 received from the subset of the plurality of space objects.

In the case of RF interference caused by other space objects, this RF interference data can be used by the interference monitoring and analysis platform 100 to not only predict RF interference but also to generate alerts that can be reported to governmental and regulatory space clients if/when the detected RF interference generated by a particular space object is determined to violate spectrum allocations, priorities and/or other regulatory rules and/or regulations. In various examples, the satellite interference sensor 304 is also configured to detect, based on an analysis of the data transmitted from the space object and/or the position of the space object, a signal interference attribution—i.e., the source of the RF interference and generates RF interference data indicating this source. In other examples, the source of the RF interference is generated by the interference monitoring and analysis platform 100 based on space system data indicating the position of the space object, the angle of arrival of the RF interference determined by the satellite interference sensor 304, spectral data indicating the frequency of the RF interference and/or the transmission frequency/spectral signature of the space object.

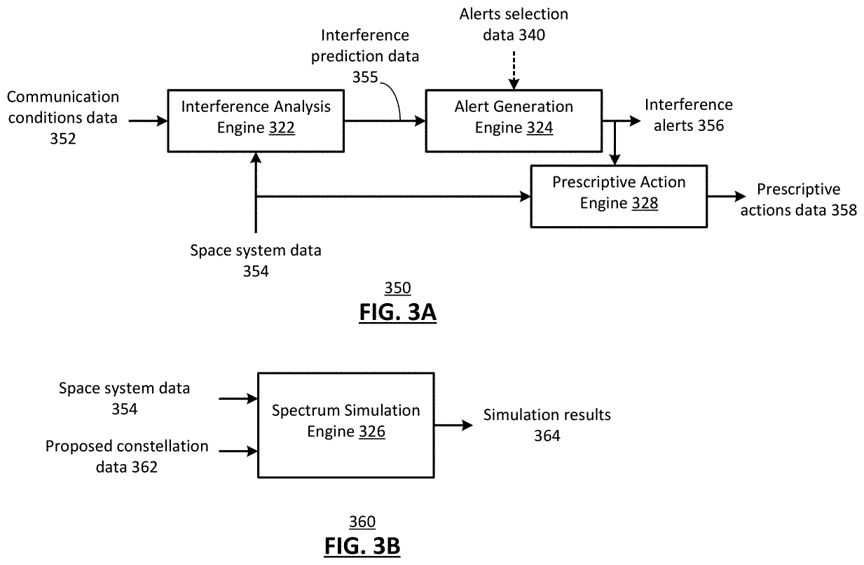

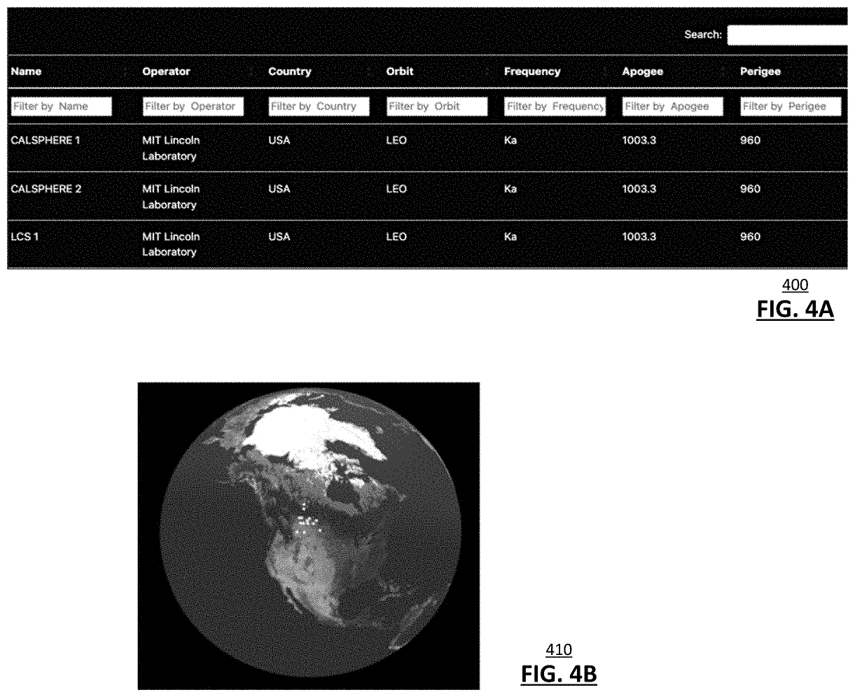

FIG. 3A is a schematic block diagram of a portion of an example interference monitoring and analysis platform in accordance with various embodiments. In the example shown, the interference analysis engine 322 responds to the communications condition data 352 and the space systems data 354 by generating interference prediction data 355 that indicates at least one predicted interference condition corresponding to communications corresponding to at least one of the plurality of space objects.

As previously discussed, the space system data 354 can include operator and space object data such as the names, operators, two-line element sets, special perturbation vectors and/or other orbital state vectors (e.g., position, velocity, orbit, pointing data and/or other orientation data and/or data associated with current and/or planned maneuvers), and/or uplink, downlink, intersatellite frequencies and/or other spectral information associated with the plurality of space objects being monitored by the interference monitoring and analysis platform 100, in addition to signal regulations data such as spectral and other communication rules established by the Federal Communication Commission (FCC), the International Telecommunication Union (ITU), and/or other regulatory or standards organizations.

As previously discussed, the communication conditions data 352 can include weather service data 204 indicating atmospheric conditions adverse to space communications (received from one or more weather services, for example) and radio frequency (RF) interference data indicating space-originating RF interference adverse to space communications. It should be noted that this detected RF interference could be present any RF frequency band, including, but not limited to, any portion of the RF spectrum that is used for satellite communications and/or that could otherwise present a threat to the integrity of a space object. At least a portion of the RF interference data can be received from a plurality or ground stations 202 such as radio telescopes or other radio astronomy systems, antenna/receiver systems dedicated to interference monitoring and/or to the interference monitoring and analysis platform 100, antenna/receiver systems of amateur and/or commercial radio operators and/or stationary and/or mobile systems that receive corresponding RF interference 201. In addition or in the alternative, at least a portion of the RF interference data is generated via a plurality of sensors (such as small component satellite sensor hardware) corresponding to or otherwise incorporated with a subset of the plurality of space objects, wherein each of the plurality of sensors is dedicated to detection of space-originating RF interference adverse to space communications (generated either celestially of via one or more other space objects), and wherein the at least a portion of the RF interference data generated by such sensors is incorporated into downlink communications received from the subset of the plurality of space objects.

Consider the following example where disruptive RF interference is detected corresponding to a solar disturbance in the X, Ku, K and Ka frequencies bands, the orbital regions above the Earth to be most affected can be predicted based on their proximity to the poles, the position of the Earth relative to the sun and furthermore the rotation of the Earth. This disruptive RF interference can be identified by the interference analysis engine 322 based on comparison of the amount of RF interference 201 to a disruption threshold indicating a likelihood of disruption and/or based on a plurality of thresholds indicating increasing disruptions levels. In other examples, the interference analysis engine 322 can include an AI model that is trained based on data corresponding to prior disruptions to identify, predict and/or classify a potential disruption and/or its severity. The interference analysis engine 322 also relies on a database of space systems data 354 to identify the times various space objects will be operating in these affected orbital regions using the affected frequencies bands for uplink, downlink, inter-satellite, or space link communications and generate interference prediction data 355 to indicate these predicted interference conditions including, for example, affected space objects, affected times, affected link(s), a level of disruption and/or affected locations.

Consider a further example where weather service data 204 indicates the current or predicted future severe storms in the skies above the Canadian Province of Saskatchewan that could cause degradations to uplink and downlink communications for space objects in orbital regions above this location. This potential degradation can be identified based on comparison of the intensity of the severe storm to a disruption threshold indicating a likelihood of disruption and/or based on a plurality of thresholds indicating increasing disruptions levels. In other examples, the interference analysis engine 322 can include an AI model that is trained based on data corresponding to prior storms to identify, predict and/or classify a potential degradation and/or its severity. The interference analysis engine 322 again relies on a database of space systems data 354 to identify the times various space objects will be operating in these orbital regions using the affected frequencies bands for uplink, downlink, inter-satellite, or space link communications and generate interference prediction data 355 to indicate the predicted interference conditions.

In either of the foregoing examples, the alerts generation engine 324 responds to the interference prediction data 355, to generate interference alerts 356 indicating the predicted interference condition(s) that can be proactively sent to space clients 120, such as only those particular operators corresponding to the affected space objects. In various examples, the interference alerts 356 can classify the predicted interference condition(s) as: inter-satellite communication interference, satellite uplink communication interference, or satellite downlink interference.

These interference alerts 356 can be displayed on a display device associated with a space client 120 via a graphical user interface generated by the interference monitoring and analysis platform 100 that, for example, provides a graphical display and/or a 2D or 3D visualization of these alerts. In a further example, one or more space clients can generate alerts selection data 340 via the GUI that filters the types of alerts that a particular space client would like to see, for example, by: operator, space object identifier (e.g., name), country, frequency band, orbit, apogee, and/or perigee. In this case, the alerts generation engine 324 responds to the interference prediction data 355 to generate interference alerts 356 corresponding to the selected filter parameters for display on the display device associated with the particular space client 120.

As further shown, the prescriptive action engine 328 operates based on the interference alerts 356 and portion of the space system data 356, to generate prescriptive actions data 358 that indicates prescriptive actions for mitigating the predicted interference condition(s) prior to their future occurrence. As previously discussed, these prescriptive actions can include one or more of:
adjusting a downlink transmission power of the at least one of the plurality of space objects,
adjusting a downlink transmission power of at least another one of the plurality of space objects, adjusting an uplink transmission power of a ground station communicating with the at least one of the plurality of space objects,
adjusting an uplink transmission power of a ground station communicating with the at least another one of the plurality of space objects,
rerouting an uplink transmission to the at least one of the plurality of space objects via uplink transmission to another space object of the plurality of space objects and inter-satellite communications from the another space object of the plurality of space objects to the at least one of the plurality of space objects, and/or
rerouting a downlink transmission from the at least one of the plurality of space objects via intersatellite transmission to another space object of the plurality of space objects and downlink communications from the another space object of the plurality of space objects.

Consider again the example above where severe storms are present in the skies above the Canadian Province of Saskatchewan that could cause degradations to uplink and downlink communications for space objects in orbital regions above this location. The prescriptive action engine 328 can, for example, generate prescriptive actions data 358 for affected space objects that suggests rerouting uplink and downlink communications via intersatellite signaling to one or more ground stations in other locations that are not affected by the weather.

Consider a further example where Telesat is providing backhaul cell phone reception in a Ka band over a ground station 200 in a given region (such as Montreal) and Starlink comes about and is downlinking in the same band over the given region. This co-linear vector satellite interference event can be identified and prescriptive actions data 358 can, for example, suggest that Starlink switch to a particular alternative band to avoid the interference. This alternative band may be an existing Starlink band or a currently unused band available via a spectral sharing transaction.

Consider an additional example where an earth observation satellite is dynamically downlinking based on where their customer is requesting earth imagery. The satellite operator needs to know in near real-time whether a given ground station has capacity for downlinking or if they will be interfering with other satellites communicating in the region in a similar band. The interference monitoring and analysis platform 100 can operate to identify the best possible communication channel based on the current regional communication information that has been identified and logged in the system.

FIG. 3B is a schematic block diagram 360 of a portion of an example interference monitoring and analysis platform in accordance with various embodiments. In the example shown, the spectrum simulation engine 326 of processing module 320 operates by receiving proposed constellation data 362 corresponding to a proposed constellation of space objects and the space system data 354. The spectrum simulation engine 326 of processing module 320 operates further by generating simulation results 364, based on the proposed constellation data 362 and the space system data 354. In various examples the simulation results 364 indicate resulting interference conditions associated with the proposed constellation of space objects and indicate prescriptive actions for mitigating the resulting interference conditions. In various examples the prescriptive actions could be generated by a module of the spectrum simulation engine 326 in a similar fashion to prescriptive actions data 358 generated by the prescriptive action engine 328. In further examples, prescriptive actions could be generated by the prescriptive action engine 328 based on the simulation results 364.

As previously discussed, the spectrum simulation engine 326 is specifically configured to provide simulations of new operator constellations to test for interference. This enables the interference monitoring and analysis platform 100 to, for example, provide a clearing house which sources available spectra for new satellites/constellations to operate and assists new operators in getting faster access to spectrum through demonstrating minimal interference with existing space communications.

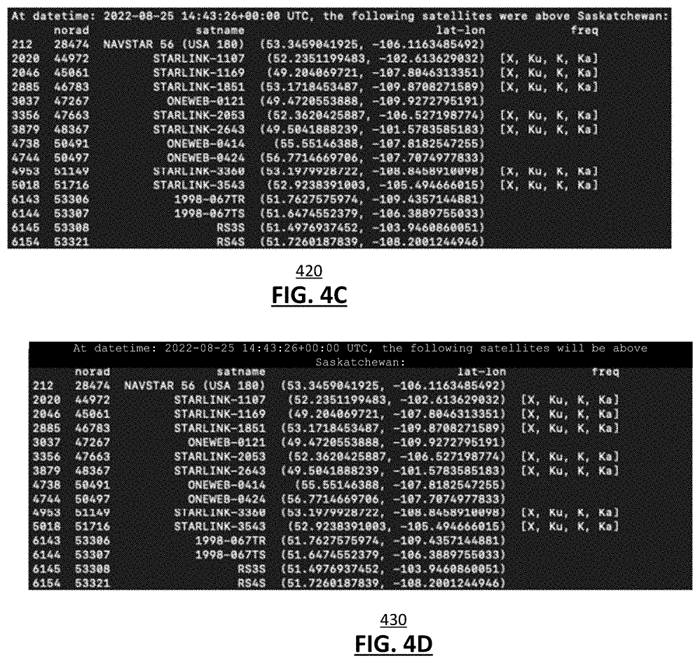

FIGS. 4A-4D are pictorial diagrams of example screen displays in accordance with various embodiments. As previously discussed, the interference monitoring and analysis platform 100 can generate a graphical user interface for display via client devices of the space clients 120.

In FIG. 4A, a screen display 400 associated with such a graphical user interface is shown that enables a space client to select display filters by name, operator, country, orbit, frequency, apogee, or perigee. In FIG. 4B, a screen display 410 associated with such a graphical user interface is shown corresponding to the previous example where severe storms are present in the skies above the Canadian Province of Saskatchewan that could cause degradations to uplink and downlink communications for space objects in orbital regions above this location. In this example, the interference alert indicates the affected space objects via a 3D visualization of their current or predicted positions at some future time above the Earth. In FIG. 4C, a screen display 420 is shown corresponding to interference alerts generated for a current time. In FIG. 4D, a screen display 430 is shown corresponding to interference alerts generated for a future time. In various examples, this future time could be generated by the interference analysis engine 322 or selected by the space client via the alerts selection data 340.

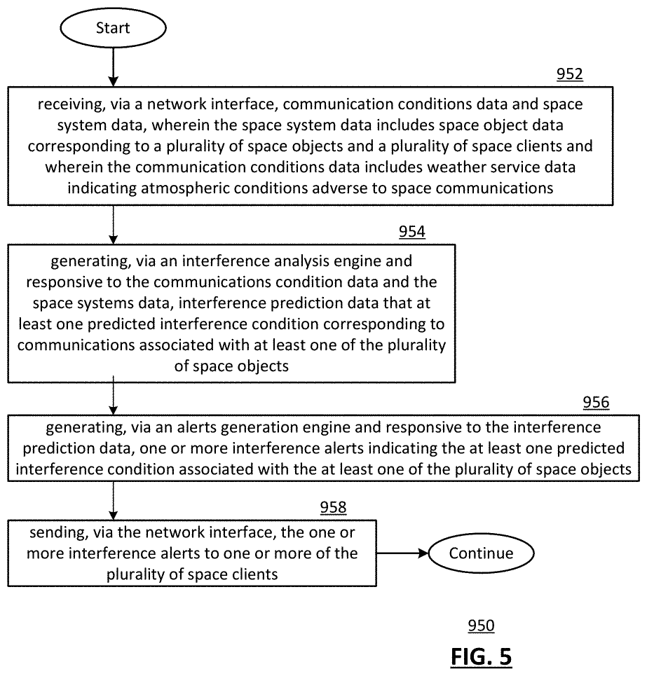

FIG. 5 is a flowchart diagram illustrating an example of a method in accordance with various embodiments. In particular, a method 950 is presented for use with one or more of the other functions and features discussed herein. Step 952 includes receiving, via a network interface, communication conditions data and space system data, wherein the space system data includes space object data corresponding to a plurality of space objects and a plurality of space clients and wherein the communication conditions data includes weather service data indicating atmospheric conditions adverse to space communications. Step 954 includes generating, via an interference analysis engine and responsive to the communications condition data and the space systems data, interference prediction data that indicates at least one predicted interference condition corresponding to communications associated with at least one of the plurality of space objects.

Step 956 includes generating, via an alerts generation engine and responsive to the interference prediction data, one or more interference alerts indicating the at least one predicted interference condition associated with the at least one of the plurality of space objects. Step 958 includes sending, via the network interface, the one or more interference alerts to one or more of the plurality of space clients.

In addition or in alternative to any of the foregoing, the communication conditions data further includes radio frequency (RF) interference data indicating space-originating RF interference adverse to space communications.

In addition or in alternative to any of the foregoing, at least a portion of the RF interference data is received from a plurality of radio telescopes.

In addition or in alternative to any of the foregoing, at least a portion of the RF interference data is generated via a plurality of sensors corresponding to a subset of the plurality of space objects, wherein each of the plurality of sensors is dedicated to detection of space-originating RF interference adverse to space communications, and wherein the at least a portion of the RF interference data is received via downlink communications from the subset of the plurality of space objects.

In addition or in alternative to any of the foregoing, the one or more interference alerts classify the at least one predicted interference condition as at least one of: inter-satellite communication interference, satellite uplink communication interference, or satellite downlink interference.

In addition or in alternative to any of the foregoing, the at least one predicted interference condition corresponds to a future condition.

In addition or in alternative to any of the foregoing, the method further comprises generating, via a prescriptive action engine and based on the interference alerts and at least a portion of the space system data, prescriptive actions data that indicates prescriptive actions for mitigating the at least one predicted interference condition prior to the future condition.

In addition or in alternative to any of the foregoing, the prescriptive actions include at least one of: adjusting a downlink frequency of the at least one of the plurality of space objects, adjusting an uplink frequency of the at least one of the plurality of space objects, adjusting a downlink frequency of at least another one of the plurality of space objects, adjusting an uplink frequency of the at least another one of the plurality of space objects, adjusting a downlink transmission power of the at least one of the plurality of space objects, adjusting a downlink transmission power of the at least another one of the plurality of space objects, adjusting an uplink transmission power of a ground station communicating with the at least one of the plurality of space objects, adjusting an uplink transmission power of a ground station communicating with the at least another one of the plurality of space objects, rerouting an uplink transmission to the at least one of the plurality of space objects via uplink transmission to another space object of the plurality of space objects and inter-satellite communications from the another space object of the plurality of space objects to the at least one of the plurality of space objects, or rerouting a downlink transmission from the at least one of the plurality of space objects via intersatellite transmission to another space object of the plurality of space objects and downlink communications from the another space object of the plurality of space objects.

In addition or in alternative to any of the foregoing, the method further comprises: generating, via a graphical user interface (GUI) engine, a graphical user interface for display via a client device of one of the plurality of space clients; and receiving, via the graphical user interface, alerts selection data selected by a user of the client device; wherein the one or more interference alerts are generated further based on the alerts selection data; and wherein the alerts selection data indicates at least one of: the at least one of the plurality of space objects, an operator associated with the at least one of the plurality of space objects, a spectrum associated the at least one of the plurality of space objects, a future location associated with the at least one of the plurality of space objects, or an orbit type associated with the at least one of the plurality of space objects.

In addition or in alternative to any of the foregoing, the method further comprises: receiving proposed constellation data corresponding to a proposed constellation of space objects; and generating simulation results, via a spectrum simulation engine and based on the proposed constellation data and the space system data, wherein the simulation results indicate resulting interference conditions associated with the proposed constellation of space objects and indicate prescriptive actions for mitigating the resulting interference conditions.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<-5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, “engine” and/or “processing unit” may be implemented via a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. An interference monitoring and analysis platform comprising:
a network interface configured to communicate via a network;
a memory configured to store operational instructions; and
a processor configured to execute the operational instructions, wherein the operational instructions, when executed, cause the processor to:
receive, via the network interface, communication conditions data and space system data, wherein the space system data includes space object data corresponding to a plurality of space objects and a plurality of space clients and wherein the communication conditions data includes weather service data indicating atmospheric conditions adverse to space communications;
generate, responsive to the communications condition data and the space systems data, interference prediction data that indicates at least one predicted interference condition corresponding to communications associated with at least one of the plurality of space objects;
generate, responsive to the interference prediction data, one or more interference alerts indicating the at least one predicted interference condition associated with the at least one of the plurality of space objects; and
send, via the network interface, the one or more interference alerts to one or more of the plurality of space clients.

2. The interference monitoring and analysis platform of claim 1, wherein the communication conditions data further includes radio frequency (RF) interference data indicating space-originating RF interference adverse to space communications.

3. The interference monitoring and analysis platform of claim 2, wherein at least a portion of the RF interference data is received from a plurality of radio telescopes.

4. The interference monitoring and analysis platform of claim 2, wherein at least a portion of the RF interference data is generated via a plurality of sensors corresponding to a subset of the plurality of space objects, wherein each of the plurality of sensors is dedicated to detection of space-originating RF interference adverse to space communications, and wherein the at least a portion of the RF interference data is received via downlink communications from the subset of the plurality of space objects.

5. The interference monitoring and analysis platform of claim 1, wherein the one or more interference alerts classify the at least one predicted interference condition as at least one of: inter-satellite communication interference, satellite uplink communication interference, or satellite downlink interference.

6. The interference monitoring and analysis platform of claim 1, wherein the at least one predicted interference condition corresponds to a future condition.

7. The interference monitoring and analysis platform of claim 6, wherein the operational instructions, when executed, further cause the processor to:
generate, based on the interference alerts and at least a portion of the space system data, prescriptive actions data that indicates prescriptive actions for mitigating the at least one predicted interference condition prior to the future condition.

8. The interference monitoring and analysis platform of claim 7, wherein the prescriptive actions include at least one of: adjusting a downlink frequency of the at least one of the plurality of space objects, adjusting an uplink frequency of the at least one of the plurality of space objects, adjusting a downlink frequency of at least another one of the plurality of space objects, adjusting an uplink frequency of the at least another one of the plurality of space objects, adjusting a downlink transmission power of the at least one of the plurality of space objects, adjusting a downlink transmission power of the at least another one of the plurality of space objects, adjusting an uplink transmission power of a ground station communicating with the at least one of the plurality of space objects, adjusting an uplink transmission power of a ground station communicating with the at least another one of the plurality of space objects, rerouting an uplink transmission to the at least one of the plurality of space objects via uplink transmission to another space object of the plurality of space objects and inter-satellite communications from the another space object of the plurality of space objects to the at least one of the plurality of space objects, or rerouting a downlink transmission from the at least one of the plurality of space objects via intersatellite transmission to another space object of the plurality of space objects and downlink communications from the another space object of the plurality of space objects.

9. The interference monitoring and analysis platform of claim 1, wherein the operational instructions, when executed, further cause the processor to:
generate a graphical user interface for display via a client device of one of the plurality of space clients; and
receive, via the graphical user interface, alerts selection data selected by a user of the client device;
wherein the one or more interference alerts are generated further based on the alerts selection data; and
wherein the alerts selection data indicates at least one of: the at least one of the plurality of space objects, an operator associated with the at least one of the plurality of space objects, a spectrum associated the at least one of the plurality of space objects, a future location associated with the at least one of the plurality of space objects, or an orbit type associated with the at least one of the plurality of space objects.

10. The interference monitoring and analysis platform of claim 1, wherein the operational instructions, when executed, further cause the processor to:
receive proposed constellation data corresponding to a proposed constellation of space objects; and
generate simulation results, based on the proposed constellation data and the space system data, wherein the simulation results indicate resulting interference conditions associated with the proposed constellation of space objects and indicate prescriptive actions for mitigating the resulting interference conditions.

11. A method comprising:
receiving, via a network interface, communication conditions data and space system data, wherein the space system data includes space object data corresponding to a plurality of space objects and a plurality of space clients and wherein the communication conditions data includes weather service data indicating atmospheric conditions adverse to space communications;
generating, via an interference analysis engine and responsive to the communications condition data and the space systems data, interference prediction data that indicates at least one predicted interference condition corresponding to communications associated with at least one of the plurality of space objects;
generating, via an alerts generation engine and responsive to the interference prediction data, one or more interference alerts indicating the at least one predicted interference condition associated with the at least one of the plurality of space objects; and
sending, via the network interface, the one or more interference alerts to one or more of the plurality of space clients.

12. The method of claim 11, wherein the communication conditions data further includes radio frequency (RF) interference data indicating space-originating RF interference adverse to space communications.

13. The method of claim 12, wherein at least a portion of the RF interference data is received from a plurality of radio telescopes.

14. The method of claim 12, wherein at least a portion of the RF interference data is generated via a plurality of sensors corresponding to a subset of the plurality of space objects, wherein each of the plurality of sensors is dedicated to detection of space-originating RF interference adverse to space communications, and wherein the at least a portion of the RF interference data is received via downlink communications from the subset of the plurality of space objects.

15. The method of claim 11, wherein the one or more interference alerts classify the at least one predicted interference condition as at least one of: inter-satellite communication interference, satellite uplink communication interference, or satellite downlink interference.

16. The method of claim 11, wherein the at least one predicted interference condition corresponds to a future condition.

17. The method of claim 16, further comprising:
generating, via a prescriptive action engine and based on the interference alerts and at least a portion of the space system data, prescriptive actions data that indicates prescriptive actions for mitigating the at least one predicted interference condition prior to the future condition.

18. The method of claim 17, wherein the prescriptive actions include at least one of: adjusting a downlink frequency of the at least one of the plurality of space objects, adjusting an uplink frequency of the at least one of the plurality of space objects, adjusting a downlink frequency of at least another one of the plurality of space objects, adjusting an uplink frequency of the at least another one of the plurality of space objects, adjusting a downlink transmission power of the at least one of the plurality of space objects, adjusting a downlink transmission power of the at least another one of the plurality of space objects, adjusting an uplink transmission power of a ground station communicating with the at least one of the plurality of space objects, adjusting an uplink transmission power of a ground station communicating with the at least another one of the plurality of space objects, rerouting an uplink transmission to the at least one of the plurality of space objects via uplink transmission to another space object of the plurality of space objects and inter-satellite communications from the another space object of the plurality of space objects to the at least one of the plurality of space objects, or rerouting a downlink transmission from the at least one of the plurality of space objects via intersatellite transmission to another space object of the plurality of space objects and downlink communications from the another space object of the plurality of space objects.

19. The method of claim 11, further comprising:
generating, via a graphical user interface (GUI) engine, a graphical user interface for display via a client device of one of the plurality of space clients; and
receiving, via the graphical user interface, alerts selection data selected by a user of the client device;
wherein the one or more interference alerts are generated further based on the alerts selection data; and
wherein the alerts selection data indicates at least one of: the at least one of the plurality of space objects, an operator associated with the at least one of the plurality of space objects, a spectrum associated the at least one of the plurality of space objects, a future location associated with the at least one of the plurality of space objects, or an orbit type associated with the at least one of the plurality of space objects.

20. The method of claim 11, further comprising:
receiving proposed constellation data corresponding to a proposed constellation of space objects; and
generating simulation results, via a spectrum simulation engine and based on the proposed constellation data and the space system data, wherein the simulation results indicate resulting interference conditions associated with the proposed constellation of space objects and indicate prescriptive actions for mitigating the resulting interference conditions.
